(19) United States
(12) Patent Application Publication
(10) Pub. No.: US 2015/0193020 A1
(43) Pub. Date: Jul. 9, 2015

(54) Cushioned Mouse Pad Device

(71) Applicant: Dean Kawasawa, Rancho Cucamonga, CA (US)

(72) Inventor: Dean Kawasawa, Rancho Cucamonga, CA (US)

(21) Appl. No.: 14/146,790

(22) Filed: Jan. 3, 2014

(51) Int. Cl. G06F 3/039

(52) U.S. Cl. CPC G06F 3/0395

(57) ABSTRACT

A cushioned mouse pad device supports a mouse pad in a stable position. The device includes a panel having a top surface, a bottom surface, and a perimeter edge extending around and between the top surface and the bottom surface. The top surface is configured for supporting a computer mouse thereon to input control signals to a computer by movement of the computer mouse on the top surface. A cushion is coupled to the bottom surface of the panel and includes an exposed lower surface facing away from the panel. A bottom channel extends across the lower surface of the cushion defining a medial section of the cushion positioned between a pair of outer sections of the cushion.

### BACKGROUND OF THE DISCLOSURE

### Field of the Disclosure

The disclosure relates to cushion devices and more particularly pertains to a new cushion device for supporting a mouse pad in a stable position.

### SUMMARY OF THE DISCLOSURE

An embodiment of the disclosure meets the needs presented above by generally comprising a panel having a top surface, a bottom surface, and a perimeter edge extending around and between the top surface and the bottom surface. The top surface is configured for supporting a computer mouse thereon to input control signals to a computer by movement of the computer mouse on the top surface. A cushion is coupled to the bottom surface of the panel and includes an exposed lower surface facing away from the panel. A bottom channel extends across the lower surface of the cushion defining a medial section of the cushion positioned between a pair of outer sections of the cushion.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a cushioned mouse pad device according to an embodiment of the disclosure.

FIG. 2 is a bottom view of an embodiment of the disclosure.

FIG. 3 is a top view of an embodiment of the disclosure.

FIG. 4 is a front view of an embodiment of the disclosure.

FIG. 5 is a top front side perspective view of an embodiment of the disclosure in use.

### DESCRIPTION OF THE PREFERRED EMBODIMENT

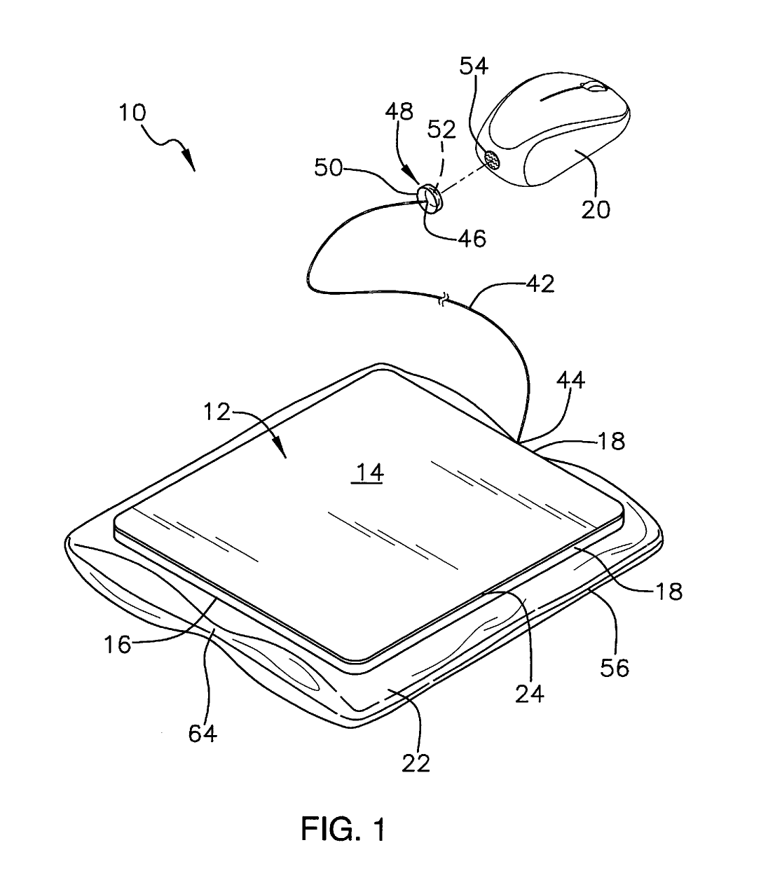

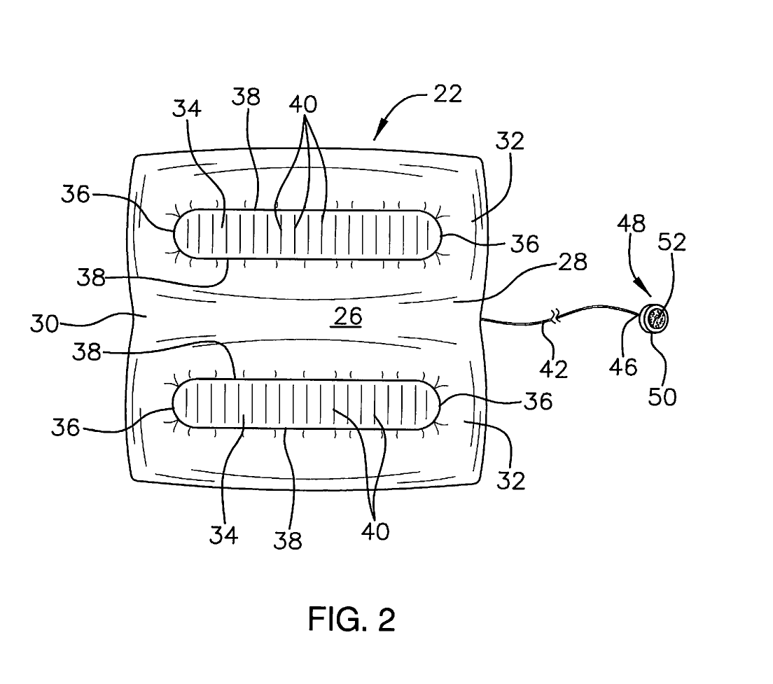

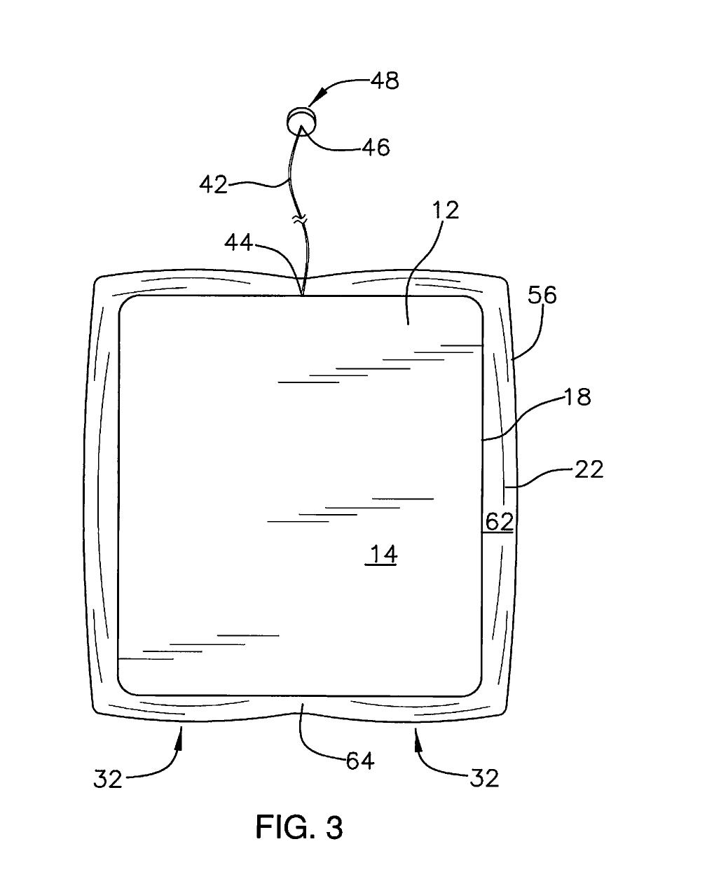

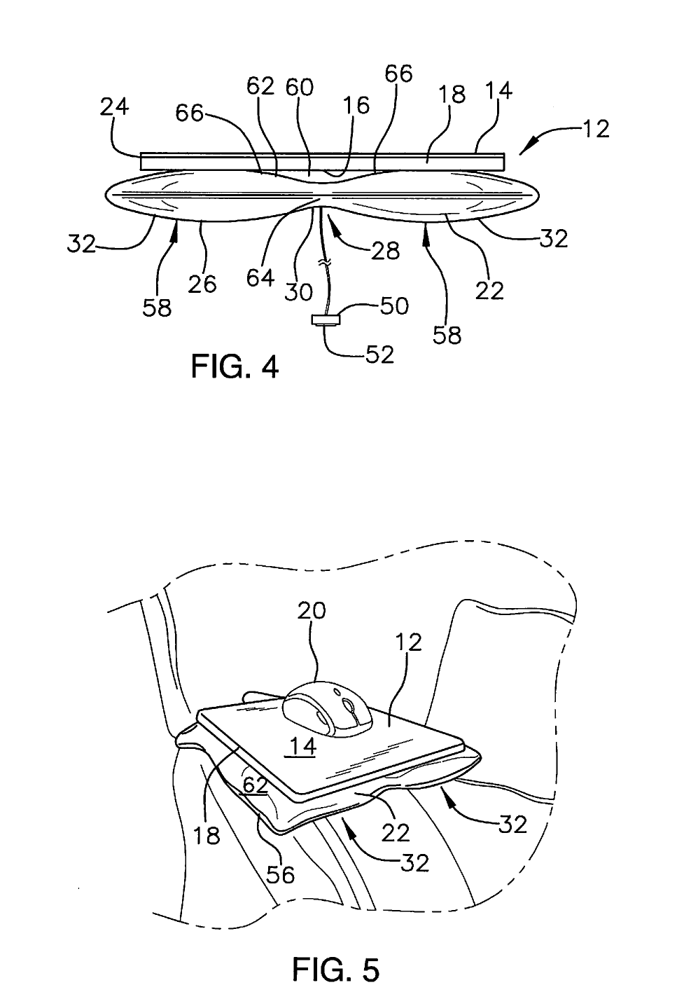

With reference now to the drawings, and in particular to FIGS. 1 through 5 thereof, a new cushion device embodying the principles and concepts of an embodiment of the disclosure and generally designated by the reference numeral 10 will be described.

As best illustrated in FIGS. 1 through 5, the cushioned mouse pad device 10 generally comprises a panel 12 having a top surface 14, a bottom surface 16, and a perimeter edge 18 extending around and between the top surface 14 and the bottom surface 16. The top surface 14 is configured for supporting a computer mouse 20 thereon to input control signals to a computer by movement of the computer mouse 20 on the top surface 14. The top surface 14 of the panel 12 is planar. The panel 12 itself is stiff to maintain a smooth surface for use of the computer mouse 20. The top surface 14 may also be comprised of a top layer 24 of material of the type conventionally provided on computer mouse pads to enhance or facilitate use of the computer mouse 20. A cushion 22 is coupled to the bottom surface 16 of the panel 12. The cushion 22 has an exposed lower surface 26 facing away from the panel 12.

A bottom channel 28 extends across the lower surface 26 of the cushion 22 defining a medial section 30 of the cushion 22 positioned between a pair of outer sections 32 of the cushion 22. Each of a pair of gripping sections 34 is positioned on the lower surface 26 of the cushion 22 on an associated one of the outer sections 32 of the cushion 22. Each gripping section 34 is elongated and may have a pair of arcuate end edges 36 and a pair of longitudinal side edges 38 extending between the arcuate end edges 36. Each gripping section 34 may have a plurality of spaced ridges 40 extending transversely between the longitudinal side edges 38 of the gripping section 34.

A tether 42 has a first end 44 and a second end 46. The first end 44 of the tether 42 is coupled to the panel 12. A coupler 48 is coupled to the second end 46 of the tether 42. The coupler 48 is configured for coupling to the computer mouse 20 such that the computer mouse 20 is inhibited from being moved away from the panel 12 farther than a length of the tether 42. The coupler 48 may be a disc 50 and a first portion of hook and loop fastener 52 positioned on the disc 50. The coupler 48 further comprises a second portion of hook and loop fastener 54 configured for being secured to the computer mouse 20. The second portion of hook and loop fastener 54 is complementary to the first portion of hook and loop fastener 52 wherein the second portion of hook and loop fastener 54 is selectively engageable to the first portion of hook and loop fastener 52.

A peripheral edge 56 of the cushion 22 extends laterally outward from the perimeter edge 18 of the panel 12 wherein the perimeter edge 18 of the panel 12 is laterally inset from the peripheral edge 56 of the cushion 22. A bottom face 58 of each outer section 32 is convexly arcuate extending transversely from the bottom channel 26. A top channel 60 extends across an upper surface 62 of the cushion 22. The top channel 60 is aligned with the bottom channel 26 defining a neck 64 extending between the outer sections 32 of the cushion 22. An upper face 66 of each outer section 32 is convexly arcuate extending transversely from the top channel 60.

In use, the cushion 22 is positionable on a supporting surface such as a bed, a person's legs, or another desired position. The cushion 22 is shaped to provide stable support of the panel 12 while the tether 42 prevent the computer mouse 20 from being lost. A computer may be controlled using the computer mouse 20 on the panel 12 remotely from the computer in a position as desired by a user.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure.

I claim:

1. A cushioned mouse pad device comprising:
a panel having a top surface, a bottom surface, and a perimeter edge extending around and between said top surface and said bottom surface, said top surface being configured for supporting an computer mouse thereon to input control signals to a computer by movement of the computer mouse on said top surface;
a cushion coupled to said bottom surface of said panel, said cushion having an exposed lower surface facing away from said panel; and
a bottom channel extending across said lower surface of said cushion defining a medial section of said cushion positioned between a pair of outer sections of said cushion.

2. The device of claim 1, further comprising a pair of gripping sections, each said gripping section being positioned on said lower surface of said cushion on an associated one of said outer sections of said cushion.

3. The device of claim 2, further comprising each said gripping section being elongated.

4. The device of claim 3, further comprising each said gripping section having a pair of arcuate end edges and a pair of longitudinal side edges extending between said arcuate end edges.

5. The device of claim 4, further comprising each gripping section having a plurality of spaced ridges extending between said longitudinal side edges of said gripping section.

6. The device of claim 1, further comprising:
a tether having a first end and a second end, said first end of said tether being coupled to said panel; and
a coupler coupled to said second end of said tether, said coupler being configured for coupling to the computer mouse such that the computer mouse is inhibited from being moved away from said panel farther than a length of said tether.

7. The device of claim 6, further comprising said coupler being a disc and a first portion of hook and loop fastener positioned on said disc, said coupler further comprising a second portion of hook and loop fastener, said second portion of hook and loop fastener being configured for being secured to the computer mouse, said second portion of hook and loop fastener being complementary to said first portion of hook and loop fastener wherein said second portion of hook and loop fastener is selectively engageable to said first portion of hook and loop fastener.

8. The device of claim 1, further comprising a peripheral edge of said cushion extending laterally outward from said perimeter edge of said panel wherein said perimeter edge of said panel is inset from said peripheral edge of said cushion.

9. The device of claim 1, further comprising said top surface of said panel being planar.

10. The device of claim 1, further comprising said panel being stiff.

11. The device of claim 1, further comprising a bottom face of each said outer section being convexly arcuate extending transversely from said bottom channel.

12. The device of claim 1, further comprising a top channel extending across an upper surface of said cushion, said top channel being aligned with said bottom channel defining a neck extending between said outer sections of said cushion.

13. The device of claim 12, further comprising an upper face of each said outer section being convexly arcuate extending transversely from said upper channel.

14. A cushioned mouse pad device comprising:
a panel having a top surface, a bottom surface, and a perimeter edge extending around and between said top surface and said bottom surface, said top surface being configured for supporting an computer mouse thereon to input control signals to a computer by movement of the computer mouse on said top surface, said top surface of said panel being planar, said panel being stiff;
a cushion coupled to said bottom surface of said panel, said cushion having an exposed lower surface facing away from said panel;
a bottom channel extending across said lower surface of said cushion defining a medial section of said cushion positioned between a pair of outer sections of said cushion;
a pair of gripping sections, each said gripping section being positioned on said lower surface of said cushion on an associated one of said outer sections of said cushion, each said gripping section being elongated, each said gripping section having a pair of arcuate end edges and a pair of longitudinal side edges extending between said arcuate end edges, each gripping section having a plurality of spaced ridges extending between said longitudinal side edges of said gripping section;
a tether having a first end and a second end, said first end of said tether being coupled to said panel;
a coupler coupled to said second end of said tether, said coupler being configured for coupling to the computer mouse such that the computer mouse is inhibited from being moved away from said panel farther than a length of said tether, said coupler being a disc and a first portion of hook and loop fastener positioned on said disc, said coupler further comprising a second portion of hook and loop fastener, said second portion of hook and loop fastener being configured for being secured to the computer mouse, said second portion of hook and loop fastener being complementary to said first portion of hook and loop fastener wherein said second portion of hook and loop fastener is selectively engageable to said first portion of hook and loop fastener;
a peripheral edge of said cushion extending laterally outward from said perimeter edge of said panel wherein said perimeter edge of said panel is inset from said peripheral edge of said cushion;
a bottom face of each said outer section being convexly arcuate extending transversely from said bottom channel;
a top channel extending across an upper surface of said cushion, said top channel being aligned with said bottom channel defining a neck extending between said outer sections of said cushion; and
an upper face of each said outer section being convexly arcuate extending transversely from said upper channel.
